(19) United States
(12) Patent Application Publication
(10) Pub. No.: US 2019/0211252 A1
(43) Pub. Date: Jul. 11, 2019

(54) METHOD OF CONTINUOUSLY PROPORTIONING AND MIXING MULTI-COMPONENT SEALANT FOR WELLS

(71) Applicant: CSI Technologies LLC, Houston, TX (US)

(72) Inventors: Freddie Lynn SABINS, Spring, TX (US); Larry Thomas WATTERS, Spring, TX (US); Jeffrey Thomas WATTERS, Spring, TX (US); Tyler JAMES, Houston, TX (US); David Duane BROWN, Cypress, TX (US)

(73) Assignee: CSI Technologies LLC, Houston, TX (US)

(21) Appl. No.: 16/099,414

(22) PCT Filed: May 10, 2017
(86) PCT No.: PCT/US17/31920

§ 371 Date: Nov. 6, 2018

Related U.S. Application Data
(60) Provisional application No. 62/391,730, filed on May 10, 2016.

(51) Int. Cl. C09K 8/44; C04B 26/14; E21B 47/00; E21B 33/138

(52) U.S. Cl. CPC C09K 8/44; E21B 33/138; E21B 47/0005; C04B 26/14

(57) ABSTRACT

A method of providing a resin based sealant to a flow line leading to a well includes determining a quantity of resin to perform a sealing operation in the well, determining a ratio of resin to a hardener to provide a hardened sealing material with desired properties establishing a flow of the resin having a resin flow rate, and, continuously mixing the resin and hardener and delivering the combined flow of resin and hardener after mixing to an injection line leading to the well while continuing to combine a further flow of the resin at the resin flow rate and a further flow of hardener at the hardener flow rate to form an additional combined flow.

### BACKGROUND OF THE INVENTION

### Field of the Invention

Embodiments of the present invention generally relate to methods and apparatii for mixing resin and hardener in a fluid state, and delivery thereof in that fluid state, for use as sealants in downhole locations of oil and gas wells. More particularly, the embodiments hereof continuously proportion hardener based on a volumetric flow of a resin base, to provide a specified desired concentration of hardener in the resin base, where the resin base has been previously combined with other necessary liquid and solid additives, and delivers the resulting fluid resin sealant mixture continuously, as it is mixed, to the desired sealing location in the well.

### Description of the Related Art

The traditional sealant used to seal oil and gas wells is Portland cement. This material can be mixed with water to form a water-based slurry at a well's location, pumped into the well, allowed to set, i.e., harden or cure, and thereby form a seal in the well in situ to seal off the production formation from the interior of the well bore. A comprehensive world-wide pumping service industry has been established to perform this task for the petroleum industry. The industry uses portable mixing equipment, along with known processes and recipes to formulate and proportion the cement, additives, and water into the required composition, and mix them together in a single batch with a mixer having sufficient shear energy to produce a uniform, stable fluid sealing mixture which is then injected into the well and subsequently sets in situ to form a seal.

At times, well construction, completion, or abandonment operations require sealants with properties that cannot be achieved using Portland cement. Examples of such more desirable sealant properties include one or more of higher seal tensile strength, higher seal bond strength to adjacent casing and formation, increased chemical resistance, and better penetration into the formation than achievable using Portland cement. In those instances, alternative sealants to Portland cement such as resin based sealants are employed. Resin drawn from a class of materials known as thermoset plastics is mixed with a hardener to form a two-part epoxy-hardener sealant. The parts of the sealant (resin and hardener) react when combined to form a cross-linked polymer network that is rigid and dimensionally stable after their inter-reaction has run to completion. This class of material is widely used in aerospace, electronics, and automotive industries as adhesives and sealants. Resulting hardened resins can be formulated which exhibit excellent adhesion, structural stability, chemical resistance, and durability under harsh conditions.

An absolute requirement for application of resin based sealants is thorough intermixing of the resin and hardener components thereof. Less than complete intermixing of the resin and hardener will yield a mixture having portions thereof in an adequately intermixed state, and other portions where the resin and hardener will remain in the mixture in an unreacted state after the adequately mixed portion has reacted, resulting in a sealant with islands or volumes of inadequate sealing properties, i.e., a heterogeneous product having varying and unreliable sealant properties as a result of incomplete crosslinking is formed. A homogeneous mixture of resin and hardener resulting from thorough intermixing of the components is required for adequate sealant performance of the sealant in the well.

Current oilfield mixing and placement techniques used for fluid resin sealant mixtures requires batch mixing of the required sealant volume or resin, hardener and non-hardener additives to ensure proper formulation and a thorough, homogeneous mixture. The total volume or mass of fluid resin sealant mixture mixed is based on the properties of the well to be sealed, including the expected volume of the sealant that will penetrate into the production formation, the volume required in the annulus around the production casing and spanning a desired distance from below to above the production zone, and the volume required to be in the production casing bore and spanning a desired distance from below to above the production zone being sealed off. Thus, the volume of sealant for any one sealing application can significantly vary, based on expected penetration into the production zone, the size of the production casing and thus the cross section of the annulus and inner bore of the production casing, the height or length of the set seal, and the expected pressure in the formation which may tend to push the set seal from the sealing location. However, these batch mixing techniques are known to lead to either a heterogeneous resin and hardener mixture being pumped into the well, or a homogeneous mixture, formed by extending the mixing time, is pumped into the well, but the setting time, i.e., the time before the mixture hardens or cures, can prevent the entire batch of sealant from being injected into the well and reach the sealing location before the sealant mixture hardens, thereby resulting in a failed sealing job. Additionally, sealing applications where a well owner wants the added security or enhanced sealability provided by a resin based sealant sometimes cannot be performed, or are performed using a less than an optimal fluid resin sealant mixture composition, because the fluid resin sealant mixture cannot be mixed and then pumped to the sealing location before some or all of it sets. In all three cases, the issues occur because the reaction of the resin and hardener is temperature driven, in that the reaction rate increases as the temperature of the mass of resin and hardener increases, and the reaction is also exothermic, such that the reaction rate further increases due to heat given off during the reaction of the resin and hardener. Therefore, as the amount of fluid resin sealant mixture, and thus the volume of the mixed batch of fluid resin sealant mixture becomes larger, the sealing application operator is tempted to inject the sealant into the well before it is fully mixed, i.e., in the heterogeneous state, so that it does not harden before the entire batch is delivered to the sealing location, which yields the problems associated with inadequate mixing, reduce the total volume or mass of sealant used, which can also lead to failure of the seal in the well, or provide a less than optimal hardener amount leading to a seal with less than optimal sealing properties.

Setting times for the resin, in other words the time from when the mixture or resin, hardener, and other additives is first mixed together but not homogenous, to the time where the mixture hardens to form the seal, can be controlled by varying the hardener composition, but reaction control is complicated by the exothermic reaction between the resin and hardener components, and where a large mass (and resulting large volume) of resin and hardener are intermixed, the inability of the heat of reaction to conduct, convect or radiate out of the large mass of the mixture, known as the mass effect, whereby the temperature of the mixture cannot be controlled due to the added heat of the reaction driving an even faster reaction of the mixture. As the temperature of the mass of the mixture increases, the reaction rate of the mixture being used to form the sealant increases. As the volume of the mixture of resin and hardener increases, the thermally-induced acceleration of the reaction rate likewise increases accordingly. This complicates resin formulation to ensure adequate handling or application time, because the desired quantity of resin and hardener needed to perform the sealing operation cannot be mixed and delivered within the time period before the homogenous mixture hardens to the point where it either cannot be pumped down a sealant line to the well location to be sealed, or, can be pumped, but has partially hardened or set to the point where its ability to seal is compromised.

Resin sealant volumes required for oil and gas wells are usually significantly larger than volumes used in traditional applications thereof such as automotive and aerospace applications. Typical resin volumes for well sealing range from 21 gallons (½ barrel) to over 2000 gallons (50 barrels). Also, the temperature at the sealant application location varies according to the sealing location in the well. Sealant application temperatures, i.e., the temperature of the well at the location where sealing is to be effected, can range from 36° F. at the mud line of a deepwater well to well over 300° F. at depths thousands of feet below the surface. However, no matter the final application temperature for the sealant, the initial mixing of the sealant components into the fluid resin sealant mixture must be performed at the earth's surface, and thus at the surface ambient conditions, before the introduction thereof into the well. Therefore, no matter what the final application temperature is for the fluid resin sealant mixture, the components thereof must be initially intermixed at the earth's surface from component materials stored at temperatures usually ranging from 60° F. to 100° F. The delivery times required for fluid resin sealant mixture placement, during which the fluid resin sealant mixture must remain in the fluid state, range from 1 hour to 12 hours or more depending on the sealing location in the well (depth) and placement method of the fluid resin sealant mixture. Once in place, the fluid resin sealant mixture must harden and form the desired seal within 12 to 72 hours to be commercially and operationally useful.

The type of hardener and the concentration thereof in the final resin-hardener and additive mixture are tailored to produce desired resin set times and sealant properties in the well. Fluid resin sealant mixtures for lower application temperatures (a range from below temperature of mixing to 20-30° F. greater than temperature of mixing) uses a hardener which reacts at the lower application temperatures, which is at or close to the mixing temperature, and thus presents two reaction control issues when mixed in a batch:
1. The time required for mixing and placing the batch at the sealing location will be very near the mixture's handling time, i.e., the time before the mixture sets or hardens; and
2. The mass effect of large resin volumes (greater than 5 gallons) will accelerate the reaction rate as a result of self-heating as the exothermic reaction initiates.

Additionally, premature reaction of large volumes of sealant can generate sufficient heat to raise the material's temperature to over 500° F. creating serious health, safety and engineering (HSE) hazards. Even though this concern is greater for resin formulations designed for lower temperature applications, the mass-effect hazard exists for fluid resin sealant mixtures designed for high temperature applications as well. To address these problems, the industry employs fast batch mixing of lower-temperature formulations of resin and hardener components to form the fluid resin sealant mixture at surface conditions, to avoid having the fluid resin sealant mixture setting or hardening prior to placement. This often necessitates a design of the sealant mixture having a lower hardener concentration than would provide optimal sealing properties so that the mixing of the resin and hardener, and placement of the fluid resin sealant mixture before it hardens, can be achieved.

Large volumes of fluid resin sealant mixture designed for elevated temperature sealing applications (e.g. with high temperature hardener at a concentration to allow placement at 275° F.) will begin hardening even at ambient surface temperature in a matter of hours. Once this starts, the mass effect drives the reaction very quickly generating heat that further accelerates the reaction by further increasing the reaction rate. Thus, even a fluid resin sealant mixtures designed for high temperature applications can initiate hazardous and costly conditions if large volumes of mixed resin are kept too long in a batch mixer or otherwise in a large volume at the surface.

Application of fluid resin sealant mixture as a sealant for oil and gas wells requires large volumes of resin, additives and hardener to be thoroughly intermixed and properly located in the well. Batch mixing limits the hardener concentration for fluid resin sealant mixtures for lower temperature applications. Exothermic reaction and mass effect increase risk of premature reaction of batch-mixed fluid resin sealant mixtures.

### SUMMARY OF THE INVENTION

The present invention is a method of continuously mixing resin, additives and a hardener to form a fluid resin sealant mixture in a fluid state, and continuous delivery thereof to the sealing location in the oil and/or gas well as it is mixed. The method continuously proportions hardener into a resin base at a user specified concentration, where the resin base has been previously combined with other necessary liquid and solid additives, for delivery to the sealing location of a well. As a result, a fluid resin sealant mixture where user specified concentrations of the hardener in the resin, and thus a user specified ratio of resin to hardener, is readily formulated and continuously flowed therefrom for ultimate delivery thereof into the sealing location of the well, while mixing and delivery continue within the mixture handling time, including where the volume of sealant or the application temperature of the sealant resulted in handling times of the batch mixture that prevented a desired concentration of hardener in the resin, and thus resin to hardener ratio, in the sealant mixture for optimal sealing properties of the sealant. By continuously mixing and delivering the sealant mixture, the operator is freed from the constrains imposed by the mass effect and rapid setting of sealant used in low temperature sealing applications, and also freed from the undesirable hardening of a portion of a batch of sealant before the entire batch of sealant is delivered to the sealing location in the well.

Herein, a resin containing mixture of a base resin also containing fluid an dry additives therein, and a hardener containing material providing a desired quantity (weight) of hardener based on the quantity (weight) of resin in the resin containing mixture are intermixed by their simultaneously passing through one or more pumps, and then optionally a mixer, to yield a homogeneous fluid resin sealant mixture which is then pumped to the well for locating thereof at the sealing location in the well. Providing the proper quantity of the hardener to resin to form a homogenous mixture thereof in the fluid resin sealant mixture, wherein sufficient hardener is provided to provide the desired degree of reaction of the resin to form a sealant having desired properties, is in one aspect herein provided by measuring the flow rate of a resin containing material having a known quantity of resin therein, whereby the volume flow rate of the resin containing material is directly representative of the mass flow rate of resin based on the concentration of resin in the mixture, and providing a volume flow rate of hardener, whereby the volume flow rate of hardener is directly representative of a known mass flow rate of hardener, based on the mass of the resin in the resin containing mixture. This may be controlled by measuring the volume flow rate of the resin containing material and hardener containing material using flow meters, which provide a signal indicative of the flow rate therethrough to a controller employing control software. Based on the desired mass ratio of hardener to resin in the final mixture, the flow rate of one or both of the resin containing material and hardener containing material to provide the desired mass ratio of resin to hardener can be changed. Alternatively, this proportioning of hardener to resin can be inferentially achieved by manually controlling a hardener injection pump based on total flow rate of the hardener and resin mixture to the well.

By continuously proportioning and mixing the resin mixture and hardener material and immediately, and thereafter continuously, delivering the resulting fluid resin sealant mixture to the well as the remaining portion of the resin mixture and hardener material are intermixed, the range of useable resin sealing mixture performance properties can be increased, waste is reduced, and the HSE risk of an out of control exothermic reaction is significantly reduced. No large batches of resin are held at the surface to experience an increased reaction rate resulting from the exothermic reaction of the hardener and resin or from the mass effect, and thus hardening thereof, and resin based sealing applications not previously possible are rendered possible hereby.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic showing the elements of the continuously proportioning mixing and delivery system hereof.

FIG. 2 is a chart of materials.

### DETAILED DESCRIPTION

Herein, a flow of a resin mixture having a known mass of reactable resin per unit volume thereof measured in lbs/in³ or gms/cm³ is continuously mixed with a flow of hardener material having a known mass of hardener reactant for the resin per unit volume thereof measured in lbs./in³ or gms/cm³ to form a fluid resin sealant mixture, and thereafter direct the fluid resin sealant mixture to a sealant flow line to direct the sealant to the sealing location of the well.

To provide the volume of fluid resin sealant mixture necessary to effectively and satisfactory perform the sealant application, a mass of the resin mixture at least as large as needed to supply the volume of resin for the sealing application, and a mass of the hardener material at least as large as needed to react as desired to form the designed sealing mixture are weighed and located adjacent to a continuous mixing system. The resin mixture is previously mixed with additives such as surfactants, weighing materials, and other materials useful to modify the fluid properties of the fluid resin sealant mixture, the sealing properties of the resultant set resin seal, or both. Thereafter, the resin mixture and the hardener material are each flowed continuously to a mixing location, wherein portions of the are continuously intermixed and immediately flowed to the sealant injection line for delivery to the sealing location of the well. The actual volume of the resin mixture and the hardener material being mixed at any given point in time is extremely small as compared to the total volume of sealant required for the sealing application, often less than 1.0% or less of the total sealant volume needed for sealing, and by continuously intermixing the resin mixture and the hardener material, and immediately flowing it to the sealant injection line, the total volume of the fluid resin sealant mixture is mixed, and delivered to the well. Preferably the fluid resin sealant mixture is flowed into the well in a continuous stream, but can be provided as a plurality of individual shorter continuous streams. Additionally, the mixing is continuous, and thus the sealant flows to the sealing location continuously, without interruption spatially or temporally, so a continuous supply of sealant is received at the well sealing location. However, in contrast to the prior art batch mixing method, the time between when the resin mixture and hardener material are mixed together to form the fluid sealant mixture thereof and when this fluid sealant mixture exits the sealant injection line in the wellbore or annulus is relatively constant, because the time when the first portion of the fluid resin sealant mixture to be mixed leaves the mixing location to the time it reaches the sealing location, and the time when the last portion of the fluid resin sealant mixture to be mixed leaves the mixing location to the time it reaches the sealing location, are approximately the same time, limited only by conditions in the well. Additionally, the methods and apparatii hereof enable the ration of hardener to resin to be varied “on the fly” if desired, so that the relative ratios thereof can be changed to better tailor the fluid resin sealant mixture to the ambient setting condition in the well where it will set.

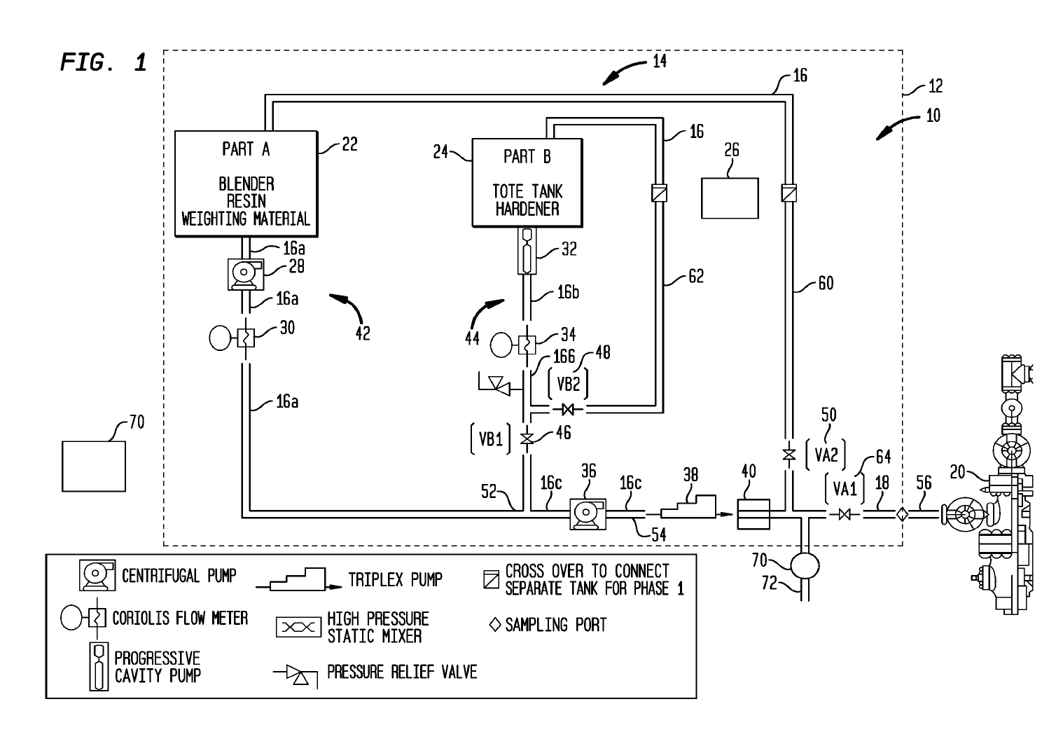

Referring initially to FIG. 1, a mixing and delivery system 10 including the operational equipment 14 and piping 16 needed to continuously provide and intermix the resin mixture and hardener material, and deliver the resulting fluid resin sealant mixture to the sealant injection line 18 for delivery to the wellhead 20 or other pressure control device at the well is shown schematically. In the embodiment described, the mixing and delivery system 10 may be skid mounted onto a number of individual skids to enable easy movement thereof to and from an offshore platform for performing sealing operations on one such platform and thereafter be moved to a different offshore platform to perform sealing operations at that production platform, or for easy loading and unloading thereof onto a work boat employed to seal sub-sea wells. However, the mixing and delivery system may be moved on a truck or other vehicle for terrestrial well sealing operations, and may also be permanently built onto the vehicle without the use of skids.

The mixing and delivery system 10 includes a batch mixer 22, one or more removable totes receivable in a tote holder 24, a scale 26, a first centrifugal pump 28, a first flow meter 30, a progressive cavity pump 32, a second flow meter 34, a second centrifugal pump 36, a high pressure triplex pump 38, and a high pressure static inline mixer 40, all interconnected by flowlines 16, wherein the flowlines 16 are selectively opened and closed, and thus in, or not in, fluid communication with one another, by selectively opening and closing valves as will be described herein. The batch mixer 22, first centrifugal pump 28 and first flow meter 30 are connected together in series by first flowlines 16a to form a resin mixture delivery line 42, wherein the resin for the sealant, and additives such as diluent, surfactant, along with other additives, are placed in the batch mixer 22 and mixed together thoroughly, and then pumped by the centrifugal pump 28 through the first flow meter 30. Because the resin mixture mixed in the batch mixer does not include the hardener, the mixing time of the resin and the additives therein has no impact on the hardening or setting time of the resin. The tote(s) receivable in the tote holder 24, progressive cavity pump 32 and second flow meter 34 are connected together in series by second flowlines 16b to form a hardener material delivery line 44. The hardener material delivery line 44 further includes a first hardener valve 46 downstream of the second flowmeter 34 to selectively open and close the outlet of the hardener delivery line 44. The hardener material delivery line 44 and the resin mixture delivery line 42 are joined together at a junction 52 downstream of the first hardener valve 46 to jointly enter into the inlet of the second centrifugal pump 36. The resin mixture flowed from the resin mixture delivery line and the hardener material flowed from the hardener material delivery line 44 joining at the juncture flow into and are initially mixed in the second centrifugal pump 36, and pumped therefrom through fluid sealant flowline 16c into the high pressure triplex pump 38 and then, if needed, the high pressure static inline mixer 40 for delivery through the sealant injection flowline 56 to the wellhead 20 and thence into the well. The suction at the second centrifugal pump 36 is sufficient to pull the flow of the hardener material and resin mixture thereinto.

To operate the system to deliver a fluid sealant mixture to the well, the flow rates of the resin mixture and the hardener material through the components of the mixing and delivery system 10 must be calibrated. To provide this functionality, feedback loops, including a resin return line 60 selectively communicable through a first return valve 50 to return fluid that has flowed through the second centrifugal pump 36, the high pressure triplex pump 38 and high pressure static inline mixer 40 back to the batch mixer 22, and a hardener return line 62 selectively communicable with the hardener flow line 16b through a hardener return valve 46 located downstream of the second flowmeter 34 and upstream of first hardener valve 46 to selectively return hardener that has been pumped through the second flow meter back to the tote 24, are provided. Using the return lines 60, 62, the flows of the resin mixture and the hardener material can be isolated from one another during calibration.

During a mixing and delivery operation of the mixing and delivery system 10 to flow the fluid resin sealant mixture to the well, i.e., during sealant injection into the well through the sealant injection line 56, hardener return valve 48 and resin mixture control valve 50 are closed to prevent fluid flow therethrough, and resin mixture pumped from the mixing blender 28 and hardener material pumped from a tote in the tote holder 24 meet at the inlet to the second centrifugal pump 36 where their intermixing is initially performed. During set up of the mixing and delivery system 10, the flow rate of hardener is calibrated to the flow rate of the resin mixture. To perform this operation, a sealant injection flowline valve 64 is located downstream of the high pressure static in-line mixer 40 between the high pressure in-line static mixer 40 and the sealant injection flowline 56, and this a sealant injection flowline valve 64 is closed and the sealing resin return valve 50 is opened. First hardener valve is closed cutting of the hardener material delivery line from the second centrifugal pump 36 while the resin in the batch mixer 22 continues to be pumped by the first centrifugal pump 28. As a result, resin mixture passing through the in line mixer 40 is returned to the batch mixer 22. During calibration, because the hardener return valve 46 is closed no hardener flows to the junction upstream of the second centrifugal pump 36, and the sealant injection flowline valve 64 is closed, while the resin mixture is fed from the batch mixer into the inlet of second centrifugal pump, and hence, the pumping and mixing components 10 and flowlines are primed with the resin mixture in fluid form, and the resin and additive components of the resin mixture become thoroughly intermixed. At the same time, hardener is pumped from tote 24 by the progressive cavity pump 32, through the second flow meter 34, and back to the tote 24 by opening valve 48 while operating progressive cavity pump 32. The total volume of resin, additives and hardener in the system is on the order of ½ of a barrel.

The resin mixture in the batch mixer 22, flow lines 16a, 16c and resin return line 60 have a known weight percent of resin therein based on the recipe or formulation used by the sealing operation operator, which corresponds to a known mass of reactable resin therein per unit volume thereof based on the sealant formulation recipe. Thus, by determining the flow rate of the resin mixture through the first flow meter, and knowing the volume to weight ratio of resin to the resin mixture based on the formulation or recipe thereof, the mass or weight of reactable resin flowing through the first flowmeter 30, flow lines 16a, 16c and resin return line 60 per unit volume, and unit time, is likewise known. Likewise, the hardener material in the totes, flow lines 16b and the hardener return line 62 has a known weight or mass of hardener therein per unit volume, and a weight per unit time passing through the second flowmeter 34, based on the formulation or recipe thereof. The sealant application operator will determine a sealant composition, commonly known as the sealant design or recipe, which incorporates a specific percentage or proportion of hardener, by weight, to the weight of the resin in the resin mixture, to obtain the desired hardening and sealing properties of the resulting sealant for a specific well sealing operation. These properties can include the percentage of available reactable resin in the resulting fluid resin sealant mixture, the type of resin and hardener used, and the strength, viscosity and other properties of the sealant in both fluid and hardened form. At a given pumping set point resulting in a resultant flow rate of resin, the operator determines the proper volume of hardener to mix therewith per unit of time to yield the desired fluid sealant mixture to be pumped into the sealant injection flowline 56, and thus determines the hardener material flow rate to deliver the desired weight of hardener per unit time based on the resin mixture flow rate and the weight of resin therein, to provide the desired hardener material flow rate to deliver the desired weight or hardener per unit time. Because the hardener material and resin mixture are mixed in a flow path leading directly to the well, they are continuously pumped, or drawn into, the second centrifugal pump 36, and thus the desired ration of hardener to resin in the fluid resin sealant mixture delivered to the well is maintained as the mixture is mixed along the flow path between the second centrifugal pump 36 and the injection line 56.

One method of calibration is to divert the return flow of hardener in the hardener return line 62 to a secondary tote disposed on the scale 26, and determine the quantity of hardener material delivered to the secondary tote, by weight, in a given period of time in comparison to the output of the flowmeter reflecting the volume flow rate of hardener. This methodology provides, for a given flow rate of hardener material over a given time period, a resulting mass of hardener mixture. Knowing the weight of hardener in the hardener mixture, the rate of flow of hardener by weight through the second flow meter is known for a given output of the second flowmeter 34. As a result, the mass or weight of the hardener passing through the flowmeter 34 can be calculated by extrapolation. For example, if the second flowmeter 34 indicates a volume flow rate of 1 gallon per minute, and the weight of the hardener in the weighed hardener material drawn from the outlet of the second flowmeter 34 for one minute is 1 lb., then the weight to volume ratio of hardener passing through the second flowmeter 34 is one pound per gallon. Thus, at a flow rate through the second flowmeter 34 of ½ gallon per minute, the hardener flow rate is ½ lb. per minute, and at 1 gallon per minute, one lb. per minute. The flow rate of the hardener can then be modified to provide the desired weight or mass of hardener per unit of time to the inlet of the second centrifugal pump 36 corresponding to the desired or calculated quantity, based on the corresponding weight based flow rate of the resin mixture measured at the first flowmeter 30. The actual quantity of resin in the resin mixture flow can be calibrated to the first flowmeter 30 resin mixture flow reading in a similar operation, wherein a quantity of the resin mixture is dispensed into a tote on the scale 26, and the weight or mass of resin mixture dispensed to the tote on the scale 26 over a measured period of time is used to calibrate the first flow meter 30 to reflect the actual flow rate of resin, by weight, therethrough. Likewise, once the mass of hardener and mass of resin flow rates are known, they actual corresponding volumetric flow rates of the resin mixture and hardener material can be calibrated to mass, and used to set the desired ratio of hardener to resin.

Once the flow rate of the resin mixture and hardener material are calibrated so that the desired flow rate of hardener material for a given existing flow rate of recirculating resin mixture is calculated, the speed of the rotor of the progressive cavity pump 32 is adjusted to obtain a steady state flow of hardener, at the desired flow rate, recirculating to the tote in tote holder 24. Once the desired steady state flow of hardener is reached, the hardener return valve 48 is closed, while all of the pumping and mixing components continue to operate at the prior settings, to now flow the hardener material and resin mixture simultaneously through the second centrifugal pump 36, high pressure triplex pump 38, and high pressure static inline mixer 40, while simultaneously purging these same components of the resin mixture that is not intermixed with hardener, which is recirculated to the batch mixer 22. Once the resin mixture is purged from, or nearly purged from, the second centrifugal pump 36, high pressure triplex pump 38, and high pressure static inline mixer 40, the resin mixture return line valve 50 is closed and the fluid sealant mixture injection flowline valve 64 is opened, while all of the pumping and mixing components continue to operate at the prior settings and thus the relative flow rates of the resin mixture and hardener material remain the same at the desired ration, and a homogeneous fluid sealant mixture having the desired ratio of hardener and resin therein, as selected by the operator, is injected into the well to form the seal therein.

In one embodiment herein, a programmable controller 70 incorporating, or interconnected to, a memory to store program and recipe information, is operatively connected to the pumps, valves, flowmeters and mixer of the fluid mixing and delivery system 10. In this embodiment, the valves 46, 48, 50 and 64 include electromechanical actuators to set the open or closed condition of the valve under control of the controllers. The flow meters 30, 34 provide a digital signal to the controller 70 indicative of the flow rates of the resin mixture and hardener material therethrough, and each of the pumps 28, 36 and 38 are electrically controlled with a feedback system to enable the speed of pumping of fluids therethrough to be controlled. Thus, once the first and second flow meters 30, 34 are calibrated, and the operator has entered the desired pumping flow rate of the resin mixture and the ratio of hardener flow rate to resin flow rate into the controller 70, the controller operates the mixing and delivery system 10 components to first achieve the desired resin mixture flow rate and corresponding hardener material flow rates while maintaining both the resin and the hardener flow paths in the return mode, i.e., the hardener material and resin mixture do not intermix. Then, once these flow rates are at the desired flow rate and are flowing steady state, the controller 70 causes the hardener return valve 48 to close communication between the second flowmeter 34 outlet and the hardener return line 62 while simultaneously causing the first hardener valve 46 to actuate to open fluid communication of the hardener material between the outlet of the second flowmeter 34 and the inlet to second centrifugal pump 36 while the resin mixture continues to flow through resin return line 60. Based on the flow rate of the resin mixture during recirculation and the volume of fluid that can be present between the juncture 52 upstream of the inlet to the second centrifugal pump 36 and the resin return line 60, the controller determines the time from the opening of the first hardener valve 46 until a mixture of the resin mixture and hardener material will reach the resin return line, and once that time period has passed actuates the resin return line valve 50 to close of the resin return line 60 from communication with the outlet of the mixer 40, and simultaneously open communication between the outlet of the high pressure static in-line mixer 40 and the fluid sealant mixture injection line 56 to deliver the fluid resin sealant mixture to the sealing location of the well. The timing of the actuation of valves 50, 64 to cut off flow of resin to the resin return line 60 is not critical, as a small amount of a mixture of the resin mixture and hardener can be returned to the mixing blender, because it will be rapidly passed through the mixing and delivery system 10 and thus will not meaningfully effect performance of the resulting sealant, or, a small amount of resin mixture that has not been mixed with hardener can be flowed into the well without affecting the resultant seal. The controller then monitors the flows of the resin mixture and hardener material by monitoring the output of the first and second flow meters 28, 34, and where required adjusts the pumping speed of the first centrifugal pump 28 and the progressive cavity pump 32 to maintain the desired ratio of resin mixture and hardener material joining at the juncture 52 upstream of the inlet to the second centrifugal pump 36, and thereby maintain the desired ratio of flow rates, and thus weights, of the resin mixture and hardener material joining at the inlet to the second centrifugal pump 36 and concurrently moving through the mixing and delivery system 10.

Alternatively, if needed, the fluid proportions may be controlled manually based on the flow through the high-pressure triplex pump 38 as indicated from its stroke counter or tachometer. The high pressure triplex pump 38 has a known displacement of fluid therethrough per stroke. The progressive cavity pump 32 pumping the hardener material also has a known volume of fluid flow therethrough per stroke. Hence, if the controller 70 fails to control the components of the mixing and delivery system 10, the required proportion of hardener material to resin mixture in gallons hardener per gallon resin mixture can be maintained and adjusted by adjusting the pumping speed of the progressive cavity pump 32 injecting the hardener based on the flow through the triplex pump 38. Electronic control through the controller is more accurate and reliable, but proportioning can be controlled manually and mixing and injecting the fluid resin sealant mixture can continue if a situation such as controller 70 or flow meter failure 30, 34 occurs.

After the desired total quantity of the fluid resin sealant mixture is delivered to the well, based on the controller monitoring the total summed flow rate of the resin mixture measured by the first flow meter 28 over time or the summed flow rates of the resin mixture measured by the first flow meter 28 and the hardener material measured by the second flow meter 34 over time, the controller causes a chaser fluid, for example water, or when a subsea well is being sealed, seawater, into the flowline 16c downstream of the mixer 40, by opening a chaser valve 70 to allow high pressure chaser fluid from a high pressure source, such as pumped seawater, to enter the injection line 56 to the well and push the sealant down the flow line until the sealant is fully deployed from the injection line into the well. Simultaneously, the components of the mixing and delivery system 10 upstream of where the chaser fluid is introduced are flushed, such as by allowing reverse flow of the chaser fluid therethrough, or operating an isolation valve (not shown) to isolate the mixing and delivery system 10 from the flow of chaser fluid, and separately flushing the components with a flushing liquid to remove any fluid sealant mixture therefrom, so as to prevent setting of the fluid sealant mixture into a solid therein.

During the mixing operation of the mixing and delivery system 10, significant mixing occurs in the two pumps injecting the combined resin mixture and hardener material fluid stream: In the second centrifugal pump 36 which primes the suction of the triplex pump 38, and in the triplex pump 38 providing a high pressure mixture of the two feedstocks to the in-line static mixer 10. The shear energy imparted to the combined resin mixture and hardener material fluid stream by these two pumps as the fluid stream passes therethrough provides sufficient mixing energy to ensure adequate mixing of the hardener material and resin mixture to produce a homogeneous sealant therefrom. The final mixing device, the static in-line mixer 40, is provided on the outlet side of the triplex pump 38 to ensure a completely homogenously mixed fluid sealant mixture prior to its entering the well.

Alternatively, the in-line static mixer 10 can be eliminated if desired. The second centrifugal pump 36 and triplex pump 38 will typically provide sufficient mixing to produce a reasonably well mixed resin mixture that should result in adequate mechanical properties of the sealant. If the viscosity of the mixture of the resin mixture and the hardener material is not too great, the first centrifugal pump 28 can be eliminated as well, and the resin based feedstock simply gravity fed, or drawn through the first flowmeter 30 by the second centrifugal pump 36.

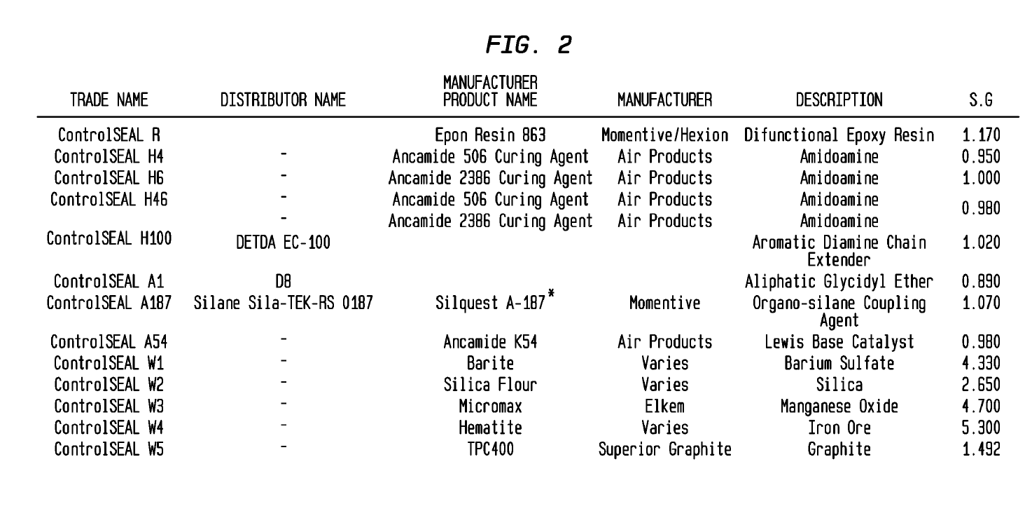

The following procedure is followed to proportion and mix resin sealant using the mixing and delivery system 10 hereof which for a specific sealing application is within the skill set of one skilled in the art:
1. Determine the desired composition of the resin material feedstock based on a specific sealing application and sealing conditions, including the mixing temperature and sealing location temperature, formation pressure, etc. This includes the amount and type of additional required diluent, hardener, bonding agents, set control additives, defoamer, weighting material(s) and other additives such as those set forth in FIG. 2. Design of the fluid resin sealant material composition is based on required sealant performance properties (e.g. viscosity, set time, strength development, bonding, shrinkage, etc.) at the application temperature of the sealant in situ in the well.
2. Calculate the volume ratio of hardener to all other materials in the composition as well as the volume ratio of hardener to the sealant mixture composed of both feedstocks.
3. Mix all sealant components except hardener into the batch mixer 28. Use a stirring paddle in the batch mixer 22 and recirculate the mixture to ensure complete intermixing thereof.
4. Store the desired ratio of hardener flow rate to resin mixture flow rate, and the desired resin mixture flow rate in the controller 70, for use with the program of the controller to control the pumps 28, 32.
5. Prime the resin mixture flow lines 16a, first and second centrifugal pumps 28, 36, and the triplex pump 38 with the resin mixture while circulating the priming volume back to the batch mixer 22 through the resin mixture recirculation line 60. This also helps fully intermix the resin mixture.
6. While recirculating hardener through the progressive cavity proportioning pump 32 and back to the tote through hardener recirculation line 62, confirm the flow rate of resin mixture is as programmed by monitoring the flow through the first flowmeter 30.

7. Open the hardener return valve 48 and open first hardener valve 46. Immediately, or after a predetermined passage of time to purge unreacted resin mixture (that not mixed with hardener) back to the batch mixer or resin mixture return line, close the resin mixture return valve 50 and open the fluid sealant injection valve 64 to allow the homogenously mixed fluid sealant to flow into the well.
8. Pump the predetermined total volume of fluid resin sealant mixture through the static in-line mixer and into the well based on the total desired flow of resin mixture of the sum of resin mixture and hardener material.

A resin based sealant mixed and pumped via this method has performance properties which can be optimized by the sealant designer, and also set quickly, to reduce costly waiting time of equipment at the well. Additionally, any well issue which would prevent placement of all or part of the resin to the sealing location will not result in a large mixed resin volume remaining unused on the surface to harden, because the fluid resin sealant mixture is continuously mixed, and thus the resin and hardener are not intermixed until needed and no unmixed quantity exists other than that in the mixing and delivery system 10. This minimizes waste, reduces disposal cost, and alleviates significant HSE problems due to temperature increases form the exothermic reaction and mass effect

### Example 1

The mixing method hereof was evaluated in two full-scale tests. Equipment for the test was configured as shown in FIG. 1. In the first example, a test was designed to demonstrate mixing capability and used two resin based feedstocks without solid weighting material therein. No actual hardener was used. Rather, a resin: diluent mixture was formulated to have similar viscosity to that of the hardener, and was used in place of hardener to simulate hardener. A different resin: diluent mixture simulated the resin mixture including the additional, non-hardener components, therein. The viscosity of this simulated resin mixture closely matched a real, field-applicable resin mixture viscosity. Resin: diluent ratios along with the resin mixture viscosity and simulated hardener viscosity are listed below in Table 1. Commercial epoxy resins and reactive diluents were used. The simulated hardener material was dyed blue and the simulated resin mixture was dyed yellow.

TABLE 1
Resin: Diluent Ratios used for Full-Scale Mixing Test

| | | 300 rpm reading Fann 35 @ |
|---|---|---|
| Fluid | Resin:Diluent | 80° F. |
| Simulated Resin Mixture | 77.5:22.5 | 380 |
| Actual Resin Mixture | — | 312 |
| Simulated Hardener | 75:25 | 214 |
| Material | | |
| Actual Hardener Material | — | 240 |

Operating the system as described above, two different simulated resin mixture: simulated hardener material ratios were simulated at two different flow rates. These are summarized in Table 2.

TABLE 2
Injection rates of simulated hardener material and total flow rate

| | Simulated | | |
|---|---|---|---|
| | Hardener | | |
| | Material:Simulated | | Simulated |
| | Resin | Calculated | Hardener Material |
| | Mixture Ratio | Downhole Rate | Injection |
| Test | (gal/1000 gal) | (gal/min) | Rate (gal/min) |
| Low rate-low | 151.5 | 21 | 2.8 |
| concentration | | | |
| Low rate-hi | 481.1 | 21 | 6.8 |
| concentration | | | |
| Hi rate-low | 151.5 | 126 | 16.6 |
| concentration | | | |
| Hi rate-hi | 481.1 | 126 | 40.9 |
| concentration | | | |

Instantaneous flow rate data for the two fluid streams of the simulated resin mixture and simulated hardener material were not taken. However, total volumes flowed were measured and average flow rates were compared to the desired rates to obtain the designed/desired ratio in the resulting simulated fluid resin sealant mixture. The measured data agreed with the calculated data to within +/−7% indicating continuous proportioning ratios of the simulated resin mixture to simulated hardener material were acceptable.

Samples of simulated fluid resin sealant mixture from the flow line were taken at four different sampling locations throughout the set up: ahead of the inlet to the second centrifugal pump 36 suction, at the outlet of the second centrifugal pump 36, at the outlet of the triplex pump 38, and downstream of the high pressure static inline mixer 40. Each sample was examined visually for signs of color variation that would indicate incomplete mixing. Color variations (streaks of yellow and blue in a green fluid) were evident in samples taken from the port upstream of the second centrifugal pump 36. All other samples from all other sampling locations were uniformly green indicating adequate mixing.

### Example 2

The next example employed the same sampling equipment set up, with a resin mixture containing diluent, bond enhancer, and weighting material. Actual high-temperature hardener material was used as the hardener material feedstock to create a resultant fluid resin sealant mixture. Commercially-available epoxy resin, diluent, hardener, bonding enhancer, and barite weighting agent were used as hardener material. The formulation was resin+33.1% diluent+10% bond enhancer+123% Barite mixed with 25.6% hi-temperature hardener. Three different flow rates were tested: 22 gal/min, 52.5 gal/min, and 84 gal/min. The tote in the tote tank 24 containing the hardener material was weighed before and after each test to confirm the actual quantity, by weight or mass, of the hardener material injected while the volume of the resin mixture actually pumped were measured using the first flowmeter 30.

Samples of the resultant fluid sealant mixture were taken downstream of the high pressure static inline mixer 10. A total of at least 4 samples were taken at each flow rate. The ratio of hardener to resin for each sample was determined by gravimetric analysis. An aliquot of each sample was placed into a centrifuge tube and weighed. The samples were centrifuged for 30 minutes. Then, the supernatant fluid was decanted and weighed. The ratio of the supernatant fluid weight to total resin weight was calculated for each sample and compared to a standard supernatant ratio versus hardener concentration chart made for each test fluid. Results, compiled in Table 3, indicate an excellent correlation between the target hardener concentration (and thus ratio of hardener to resin) of the discreet samples and the actual hardener concentration of the discreet samples. Target sample concentration for all tests was 155.7 gal hardener/1000 gal of resin and additives or 25.6%. Results below show the hardener concentration was within +/−5% variation of the percentage of hardener by weight of resin. This variation is within accepted concentration limits.

TABLE 3
Measured hardener concentration

| Flow Rate | | Measured Hardener |
|---|---|---|
| (gal/min) | Sample Number | Conc. (% by wt Resin) |
| 22 | 1 | 23.7 |
| 22 | 2 | 26.2 |
| 22 | 3 | 25.2 |
| 22 | 4 | 23.8 |
| 52.5 | 1 | 24.8 |
| 52.5 | 2 | 24.7 |
| 52.5 | 3 | 23.8 |
| 52.5 | 4 | 23.2 |
| 84 | 1 | 25.2 |
| 84 | 2 | 23.0 |
| 84 | 3 | 24.7 |
| 84 | 4 | 20.8 |

The methods and apparatus hereof are useful for forming application optimized resin seals in multiple locations, where the prior art apparatus and methods were not capable of providing a seal of optimized properties for the application, or, a resin seal could not be used because the setting time for the resin was shorter than the time needed to locate the resin in the sealing location.

In one application, for upper well abandonment, plug and abandonment (P&A) plugs are commonly disposed from 500′ below the mudline to 200′ above the mud line. The well casing to be plugged (sealed) at these locations is typically larger casing sizes between 13⅜ inches up to 30″ inches, but may be smaller, and multiple annulus plugs, where a smaller tubular, such as a production tubing line or other tubulars, is present at the plug location, may be formed concurrently with forming the main tubular plug. The sealing material is commonly located at the sealing location by being pumped through tubing, coiled tubing, or a casing valve to the sealing location in the casing to form a sealing plug. Commonly, to place the sealant, the tubular through which it is conveyed is blocked at a location below the sealing location, and the tubular is perforated, such as with a perforating gun, blast joint, or the like, adjacent to the sealing location. The sealant is pumped down the tubular, such as within a coiled tubing or other line, to the perforated location where it flows into the perforated casing, through the perforations, and into the adjacent annulus to form a seal in the casing above the packer and the adjacent annulus. Alternatively, the sealant can be directed down the annulus and flow therefrom into the casing to form the seal within the casing and the annulus, or a properly weighted sealant volume can be placed into the casing or annulus above the sealing location and fall into place to seal the casing and adjacent annulus. The sealant volume for upper plugs is usually 8-20 BBL and the ambient temperatures are relatively cool, on the order of 40° F. to 70° F.

In additional examples the methods and apparatus hereof is useful for forming Intermediate plugs, where the casing diameter is more typically 7″ inches to 13⅜″ inches, the ambient temperature is greater that an upper plug location, and because the diameter of the casing is smaller, and the volume of the sealant for the sealant is on the order of 5 to 10 BBLs, and bottom plugs and lower zone abandonment applications, where higher ambient temperatures are present, and a larger volume of sealant, on the order of 20 to 70 BBLs depending on casing size, perforation interval, and porosity of the formation and thus the quantity of sealant expected to penetrate into the adjacent formation surrounding the casing. In lower zone abandonment applications, some portion of the resin is squeezed into the formation to achieve a better seal than can be obtained with cement.

Additionally, the methods and apparatus herein can be used to provide the primary sealing of the well bore annulus between the casing and the adjacent earth in the well bore, in place of conventional cement. The volume of sealant in these primary sealing application will range from 20 BBL for a deep, small liner application to over 1000's of BBL for a surface or large intermediate sealing application.

For upper plug applications, the sealant location ambient temperature is often less than the temperature of the sealant ingredients, and thus of the mixture thereof, which commonly requires a more reactive (higher hardener concentration) mixture which resultantly has a short handling time because of the short time period before the mixture sets. For bottom plug applications, the ambient temperature of the sealing location is typically higher, and thus a sealant mixture with a high concentration of hardener is not needed, because the higher ambient temperature at the sealing location will accelerate the time before the mixture sets once it is located at the sealing location, but a greater sealant volume, of the order of 70 BBLs, must be mixed and then pumped down to the sealing location. For primary sealing applications, the bottom hole static temperature (BHST) changes along the depth of the casing, and thus different large bathes sealant, having different resin to hardener ratios need often be supplied to tailor the sealant to its expected setting temperature in the casing.

### Example 3

Applicants hereof were asked to form an upper resin based sealing plug in a Gulf of Mexico well where the well had been drilled in 7,100 ft of water and the temperature at the mudline was 40° F., as part of a plug and abandonment operation on the well. The desired seal was a 100 foot long (or tall) resin plug in an annulus between 13⅝ inch and 20 inch casing and within the 13⅝ inch casing, at 1768 feet below the mud line at a sealing location temperature of 60° F., requiring a volume of 16 BBL's of sealant, over which 48 BBLs of standard Portland cement sealant would be located to form a 300 foot long (or high) plug to meet BSEE regulations. The planned placement path for the resin slurry was through 10,000′ of 1¾ coiled tubing and through 300 feet of hose, to the subsea Wellhead, through tubing to perforations at 8868 feet below the sea surface, 1768 feet below the mudline, and into the 13⅝×20″ annulus.

This application was planned during the summer, where the surface mixing temperature would be about 100° F. Lab and large-scale simulations indicated that one could not get an optimal resin design for a final down-hole curing temperature of 60° F. to its desired location prior to the resin curing (too viscous to be pumped). Batch mixing the 16 BBL volume for 15-20 minutes to ensure adequate mixing, and then pumping through coiled tubing at 0.5 BPM meant that a portion of the resin was mixed and held at surface for almost an hour at 100° F. and it was designed to set at 60° F.

Using the methods and apparatus hereof, the application could have been performed by mixing the resin mixture and the hardener on the fly, and an optimal sealant recipe for a 60° F. ambient could have been mixed and placed into the sealing location of the well because the mixing and holding time at surface is significantly reduced because each portion of the stream of the sealant mixture being pumped to the sealing location would have been immediately pumped into the cooler ambient well immediately after the instance of hardener and resin becoming properly intermixed, with no surface holding time.

### Example 4

Applicants hereof were asked to form an upper sealing plug (final plug) for a plug and abandonment operation in a Gulf of Mexico well where the well had been drilled in 1475 feet of water, and the temperature at the mudline was 55° F. The desired seal was a 100 foot long (or tall) resin plug in 13⅝ inch casing and in the annulus between the 13⅝ inch casing and the 18⅝ inch casing at 1990 feet below sea level, or 515 feet below the mud line where the ambient temperature was 65° F. This application required 14 BBLs of resin sealant mixture. The planned placement path for the resin sealant mixture was through a casing valve on the surface and thence into the 13⅝×18⅝″ annulus, followed by displacement with 260 BBLs of seawater. At a resin mixture flow rate of 0.5 BBLs per minute (BPM), the resin sealant mixture would reach the sealing location after about 4 hours.

This application was planned for the summer, where the surface mixing temperature would be about 100° F. Lab and large-scale simulations indicated that one could not get an optimal resin design for a final down-hole curing temperature of 65° F. to its desired location prior to the resin curing (becoming unable to be pumped). Batch mixing the 14 BBL volume of resin mixture (resin, hardener and other ingredients) for 15-20 minutes to ensure adequate mixing, plus the time to pump the resin mixture through coiled tubing at 0.5 BPM, meant that a portion of the resin designed to set at 65° F. was mixed and held at surface for almost an hour at 100° F.

If the methods and apparatus hereof were available, the sealing application could have been performed by mixing on the fly, and an optimal resin mixture for an ambient temperature of 65° F. could have been located at the sealing location of the well through casing valve on the surface and thence into the 13⅝×18⅝″ annulus, thus eliminating the holding time at surface conditions by allowing the resin to immediately be pumped into the cooler well at the instance of hardener and resin inter mixing.

While the foregoing is directed to embodiments of the present invention, other and further embodiments of the invention may be devised without departing from the basic scope thereof, and the scope thereof is determined by the claims that follow.

We claim:

1. A method of providing a resin based sealant to flow line leading to a well, comprising:
determining a quantity of resin to perform a sealing operation in the well;
determining a ratio of resin to a hardener to provide a hardened sealing material with desired properties at the sealing location in the well;
establishing a flow of the resin having a resin flow rate, and, based on the flow rate of the resin and the ratio of resin to a hardener to provide a hardened sealing material with desired properties at the sealing location in the well, establish a flow of hardener at a hardener flow rate which when mixed with the flow of resin at the resin flow rate combines to yield the ratio of resin to a hardener to provide a hardened sealing material with desired properties at the sealing location in the well;
combining the flow of the resin at the resin flow rate and the flow of hardener at the hardener flow rate to form a combined flow, and introduce the combined flow to a mixer to mix the combined flow; and
delivering the combined flow after mixing to an injection line leading to the well while continuing to combine a further flow of the resin at the resin flow rate and a further flow of hardener at the hardener flow rate to form a combined flow.

2. The method of claim 1, wherein determining a ratio of resin to a hardener to provide a hardened sealing material with desired properties at the sealing location in the well comprises determining the mass of resin in a unit volume of the flow of resin and determining the flow rate of hardener based on the mass of resin in the unit volume.

3. The method of claim 2, wherein the volume of the combined flow in the mixer is less than 1% of the volume of sealant required to seal the sealing location in the well.

4. The method of claim 1, wherein the flow rate of the hardener is controlled by controlling the pumping speed of a first pump.

5. The method of claim 4, wherein the flow rate of the resin is controlled by the pumping speed of a second pump.

6. The method of claim 1, wherein the mixer comprises a third pump.

7. The method of claim 6, wherein the pump includes at least one of a centrifugal pump and a triplex pump.

8. The method of claim 1, further comprising a batch mixer, wherein the volume capacity of the batch mixer is at least as large as the total volume of resin required to perform the sealing operation.

9. The method of claim 8, wherein the volume of the combined flow is less than 0.01% of the volume capacity of the batch mixer.

10. The method of claim 1, wherein a portion of the combined flow reaches the sealing location in the well while an additional flow of resin and flow of hardener necessary to perform the sealing operation are introduced to the mixer.
